(19) United States
(12) Patent Application Publication
(10) Pub. No.: US 2026/0226223 A1
(43) Pub. Date: Aug. 6, 2026

(54) POLYURETHANE FOAM AND CUSHIONING MATERIAL

(71) Applicants: INOAC CORPORATION, Nagoya-shi, Aichi (JP); INOAC SLIMFLEX CO., LTD., Nagoya-shi, Aichi (JP)

(72) Inventors: Takuya KIRIYAMA, Chita-gun, Aichi (JP); Eiji KARIYA, Chita-gun, Aichi (JP); Ayaka ORIKASA, Chita-gun, Aichi (JP)

(21) Appl. No.: 19/155,558

(22) PCT Filed: Feb. 1, 2024
(86) PCT No.: PCT/JP2024/003212

§ 371 Date: Aug. 12, 2025

(30) Foreign Application Priority Data
Feb. 13, 2023 (JP) 2023-020328

(51) Int. Cl. C08G 18/66; C08G 18/22; C08G 18/32; C08G 18/48; C08J 9/00; C08J 9/30; C08K 3/36; H01M 10/658

(52) U.S. Cl. CPC C08G 18/6677; C08G 18/222; C08G 18/3206; C08G 18/3221; C08G 18/4808; C08G 18/4825; C08G 18/4833; C08J 9/0066; C08J 9/30; C08K 3/36; H01M 10/658; C08J 2375/08

(57) ABSTRACT

A polyurethane foam containing a polyol as a raw material, in which the polyol includes a castor oil-based polyol, and the total EO content of the polyol is 10.0 mass % or less. The polyurethane foam preferably has a Gurley air permeability of 3.0 seconds or more. The polyurethane foam preferably has a compression set at 100° C. of 10.0% or less. The cushioning material includes such a polyurethane foam and is used around the battery.

### TECHNICAL FIELD

The present invention relates to a polyurethane foam and a cushioning material, and more particularly to a polyurethane foam having both high heat resistance and low air permeability, and a cushioning material including the same.

### BACKGROUND ART

The polyurethane refers to a polymer compound having a urethane bond (—NH—C(O)O—). The polyurethane is generally obtained by reacting a hydroxyl group (—OH) of a polyol with an isocyanate group (—NCO) of a polyisocyanate. Polyurethanes are known to exhibit diverse properties by optimizing the type of polyol and/or polyisocyanate. Therefore, polyurethane is applied to various automobile parts, synthetic leather, paint, adhesives, and the like. A polyurethane foam obtained by foaming polyurethane is applied to a heat insulating material, a cushioning material, and the like.

As one of methods for producing a polyurethane foam, a method for forcibly mixing an inert gas into a polyurethane raw material containing a polyol component, a polyisocyanate component and the like to form bubbles (mechanical froth method) is known.

Regarding such a polyurethane foam, various proposals have been made heretofore.

For example, Patent Literature 1 discloses a polyurethane foam obtained by foaming and reacting a raw material mixture using a mechanical froth method, the raw material mixture containing:
(a) polyether-based polyol B having a functionality of 3, a number-average molecular weight of 3,300, and an EO ratio of 70 mol %:56 parts by weight;
(b) castor oil-based polyol 1 having a functionality of 2.7, and a number-average molecular weight of 950 (hydroxyl value: 160 mgKOH/g): 44 parts by weight; and
(c) 1,4-butanediol (crosslinking agent): 11 parts by weight.
   Patent Literature 1 describes that a polyurethane foam having a compression set at 100° C. of 20% or less is obtained by such a method.

Patent Literature 2 discloses a polyurethane foam obtained by foaming and reacting a raw material mixture using a mechanical froth method, the raw material mixture containing:
(a) polyether-based polyol (manufactured by Sanyo Chemical Industries, Ltd., SAN NIX GP-600): 60 parts by weight;
(b) castor oil-based polyol (manufactured by Itoh Oil Chemicals Co., Ltd., URIC Y-406): 40 parts by weight;
(c) light calcium carbonate: 40 parts by weight; and
(d) hydrophobic silica: 1 part by weight.
   Patent Literature 2 describes that
(A) when hydrophobic silica is contained in a raw material, in addition to its foaming action as a nucleating agent, foam uniformity is improved and foam retention is improved, and
(B) when the content of light calcium carbonate is optimized, high impact absorbability is exhibited.

Patent Literature 3 discloses a polyurethane foam obtained by foaming and reacting a raw material mixture using a mechanical froth method, the raw material mixture containing
(a) polyether polyol having a hydroxyl value of 37 mgKOH/g and a functionality of 3 (manufactured by Sanyo Chemical Industries, Ltd., SAN NIX-FA-951): 63 parts; and
(b) castor oil-modified polyol having a hydroxyl value of 90 mgKOH/g and a functionality of 3 (manufactured by Itoh Oil Chemicals Co., Ltd., URIC H-57): 63 parts.
   Patent Literature 3 describes that such a method makes it possible to achieve lower hardness of the polyurethane foam and reduce the compression set.

A polyurethane foam exhibiting rubber elasticity is used, for example, in
(a) a cushioning material around a battery or an electronic control unit of an electric vehicle,
(b) a cushioning material around a stationary storage battery, and
(c) a sealing material of a sealing portion of a solar cell. Since the interior of an electric vehicle, a stationary storage battery, or a solar cell may be exposed to a high temperature, heat resistance is required for polyurethane foam used in such applications.

In addition, in the case of assembling various devices including this type of polyurethane foam, a component made of polyurethane foam is adsorbed by an automatic adsorber, and the component is conveyed to a predetermined position. Therefore, polyurethane foam used in such applications is required to have low air permeability to the extent that it can be adsorbed by an automatic adsorber.

However, there has been no conventional example in which a polyurethane foam having both high heat resistance and low air permeability has been proposed.

### CITATION LIST

### Patent Literature

Patent Literature 1: Japanese Patent No. 5905464
Patent Literature 2: Japanese Patent Application Laid-Open (JP-A) No. 2020 084173
Patent Literature 3: Japanese Patent Application Laid-Open (JP-A) No. 2008-280447

### SUMMARY OF INVENTION

### Technical Problem

An object of the invention is to provide a novel polyurethane foam having both high heat resistance and low air permeability.

### Solution to Problem

In order to solve the above problem, the invention provides a polyurethane foam containing a polyol as a raw material, in which the polyol includes a castor oil-based polyol, and the total EO content of the polyol is 10.0 mass % or less.

### Advantageous Effects of Invention

In the case of reacting a raw material mixture containing a polyol, a polyisocyanate, a foam stabilizer, a catalyst, and a foaming gas, when a castor oil-based polyol is used as the polyol, a polyurethane foam having higher heat resistance than when only a polyether polyol is used is obtained. This is considered to be because the castor oil-based polyol contains an ester bond, and the thermal stability of the ester bond is higher than that of the ether bond.

When a polyol having a low total EO content is used as the polyol, a polyurethane foam having low air permeability is obtained. This is considered to be because lowering the total EO content of the polyol improves the compatibility of the raw materials and suppresses excessive communication of air bubbles.

### DESCRIPTION OF EMBODIMENTS

Hereinafter, an embodiment of the invention will be described in detail.

### [1. Polyurethane Foam]

The polyurethane foam according to the invention is obtained by reacting a raw material mixture (more specifically, a raw material mixture containing a polyol, a polyisocyanate, a foam stabilizer, a catalyst, and a foaming gas) containing a polyol.

### [1.1. Polyol]

### [1.1.1. Materials]

Polyols are one of the main raw materials for producing polyurethane foams.

In the invention, the polyol includes at least a castor oil-based polyol. The polyol preferably further includes a polyether polyol and a low molecular weight polyol in addition to the castor oil-based polyol. The polyol may further contain a polymer polyol in addition to these.

### [A. Castor Oil-Based Polyol]

The “castor oil-based polyol” is a type of polyester polyol, and refers to castor oil or a modified product thereof.

In the invention, the castor oil-based polyol is preferably one in which:
(a) the hydroxyl value is 50 mgKOH/g or more and 300 mgKOH/g or less;
(b) the functionality is 2.0 or more and 3.0 or less; and
(c) the EO content is less than 20.0 mass %.

When the hydroxyl value is too small, the number of reaction points decreases, and poor hardness or deterioration of compression set may occur. Therefore, the hydroxyl value is preferably 50 mgKOH/g or more. The hydroxyl value is more preferably 100 mgKOH/g or more, or 150 mgKOH/g or more.

Meanwhile, when the hydroxyl value is too large, the polyurethane foam may be excessively hard. Therefore, the hydroxyl value is preferably 300 mgKOH/g or less. The hydroxyl value is more preferably 250 mgKOH/g or less or 225 mgKOH/g or less.

In general, as the functionality of the castor oil-based polyol increases, the number of crosslinking points increases, and thus the heat resistance of the polyurethane foam is improved. In order to obtain such an effect, the functionality is preferably 2.0 or more. The functionality is preferably 2.5 or more.

Meanwhile, when the functionality is too large, the polyurethane foam may be excessively hard. Therefore, the functionality is preferably 3.0 or less. The functionality is more preferably 2.7 or less.

The “EO content (mass %) of the castor oil-based polyol” refers to the ratio of the mass of ethylene oxide units contained in the castor oil-based polyol to the total mass of alkylene oxide units contained in the castor oil-based polyol.

When a castor oil-based polyol having a high EO content is used as a raw material of a polyurethane foam, compatibility of the raw material decreases, bubbles excessively communicate with each other, and as a result, air permeability of the polyurethane foam may increase. Therefore, the EO content is preferably less than 20.0 mass %. The EO content is more preferably 10.0 mass % or less, 5.0 mass % or less, 3.0 mass % or less, or 1.0 mass % or less.

### [B. Polyether Polyol]

The “polyether polyol” refers to a polyol obtained by addition polymerization of an alkylene oxide to an initiator.

In the invention, the polyether polyol is preferably one in which
(a) the hydroxyl value is 20 mgKOH/g or more and 800 mgKOH/g or less,
(b) the functionality is 2.0 or more and 3.0 or less, and
(c) the EO content is less than 20.0 mol %.

When the hydroxyl value is too small, the number of reaction points decreases, and poor hardness or deterioration of compression set may occur. Therefore, the hydroxyl value is preferably 20 mgKOH/g or more. The hydroxyl value is more preferably 30 mgKOH/g or more, or 40 mgKOH/g or more.

Meanwhile, when the hydroxyl value is too large, the polyurethane foam may be excessively hard. Therefore, the hydroxyl value is preferably 800 mgKOH/g or less. The hydroxyl value is more preferably 600 mgKOH/g or less or 400 mgKOH/g or less.

The functionality may be at least 2.0 or more. In general, as the functionality of the polyether polyol increases, the heat resistance of the polyurethane foam is improved. The functionality is more preferably 2.3 or more, or 2.5 or more.

Meanwhile, when the functionality is too large, the polyurethane foam may be excessively hard. Therefore, the functionality is preferably 3.0 or less. The functionality is more preferably 2.9 or less or 2.8 or less.

The “EO content (mass %) of the polyether polyol” refers to the ratio of the mass of the ethylene oxide unit contained in the polyether polyol to the total mass of the alkylene oxide unit contained in the polyether polyol.

EO content affects air permeability. When a polyether polyol having a high EO content is used as a raw material of a polyurethane foam, compatibility of the raw material decreases, bubbles excessively communicate with each other, and as a result, air permeability of the polyurethane foam may increase. Therefore, the EO content is preferably less than 20.0 mass %. The EO content is preferably 10.0 mass % or less, 5.0 mass % or less, 3.0 mass % or less, or 1.0 mass % or less.

### [C. Low Molecular Weight Polyol]

In the invention, the low molecular weight polyol is preferably one in which:
(a) the hydroxyl value is greater than 800 mgKOH/g; and
(b) the functionality is 2 or more.

When the hydroxyl value is too small, the number of reaction points decreases, and poor hardness or deterioration of compression set may occur. Therefore, the hydroxyl value is preferably more than 800 mgKOH/g. The hydroxyl value is more preferably 830 mgKOH/g or more.

The functionality may be at least 2.0 or more.

Meanwhile, when the functionality of the low molecular weight polyol is too large, the polyurethane foam may be excessively hard. Therefore, the functionality is preferably 4 or less. The functionality is more preferably 3 or less.

### [D. Polymer Polyol]

The “polymer polyol” refers to a dispersion of polymer particles obtained by polymerizing an ethylenically unsaturated monomer such as acrylonitrile or styrene in a polyol such as a polyether polyol.

In the invention, the polymer polyol is preferably one in which:
(a) the hydroxyl value is 20 mgKOH/g or more and 800 mgKOH/g or less;
(b) the functionality is 2.0 or more and 3.0 or less; and
(c) the EO content is less than 20.0 mol %.

When the hydroxyl value is too small, the number of reaction points decreases, and poor hardness or deterioration of compression set may occur. Therefore, the hydroxyl value is preferably 20 mgKOH/g or more. The hydroxyl value is more preferably 25 mgKOH/g or more.

Meanwhile, when the hydroxyl value is too large, the hardness of the polyurethane foam may be excessively high. Therefore, the hydroxyl value is preferably 800 mgKOH/g or less. The hydroxyl value is more preferably 600 mgKOH/g or less or 400 mgKOH/g or less.

The functionality may be at least 2.0 or more. The functionality is preferably 2.1 or more, or 2.5 or more.

Meanwhile, when the functionality is too high, the polyurethane foam may be excessively hard. Therefore, the functionality is preferably 3.0 or less. The functionality is more preferably 2.9 or less or 2.8 or less.

The “EO content (mass %) of the polymer polyol” refers to the ratio of the mass of the ethylene oxide unit contained in the polymer polyol to the total mass of the alkylene oxide unit contained in the polymer polyol.

When a polymer polyol is used as a raw material of a polyurethane foam, when the EO content of the polymer polyol becomes too high, compatibility of the raw material decreases, bubbles excessively communicate with each other, and as a result, air permeability of the polyurethane foam may increase. Therefore, the EO content is preferably less than 20.0 mol %. The EO content is more preferably 10.0 mass % or less, 5.0 mass % or less, 3.0 mass % or less, or 1.0 mass % or less.

### [1.1.2. Content of Polyol]

### [A. Content of Castor Oil-Based Polyol]

The “content (mass %) of the castor oil-based polyol” refers to the ratio of the mass of the castor oil-based polyol to the total mass of the polyol.

When the content of the castor oil-based polyol is too low, the heat resistance of the polyurethane foam may deteriorate. Therefore, the content of the castor oil-based polyol is preferably 20.0 mass % or more. The content is more preferably 33.0 mass % or more, or 35.0 mass % or more.

Meanwhile, when the content of the castor oil-based polyol is excessive, the polyurethane foam becomes too hard even when the density of the polyurethane foam is low, and the compression adhesiveness may deteriorate. Therefore, the content of the castor oil-based polyol is preferably 80.0 mass % or less. The content is more preferably 60.0 mass % or less, and still more preferably 50.0 mass % or less.

### [B. Content of Polyether Polyol]

The “content (mass %) of the polyether polyol” refers to the ratio of the mass of the polyether polyol to the total mass of the polyol.

When the content of the polyether polyol is too low, the flexibility of the polyurethane foam may be impaired and the elongation may be reduced. Therefore, the content of the polyether polyol is preferably 20.0 mass % or more. The content is more preferably 30.0 mass % or more, or 40.0 mass % or more.

Meanwhile, when the content of the polyether polyol becomes excessive, the content of the castor oil-based polyol becomes relatively low, and the heat resistance of the polyurethane foam may decrease. Therefore, the content of the polyether polyol is preferably 65.0 mass % or less. The content is more preferably 60.0 mass % or less, or 55.0 mass % or less.

### [C. Content of Low Molecular Weight Polyol]

The “content of the low molecular weight polyol” refers to the ratio of the mass of the low molecular weight polyol to the total mass of the polyol.

When the content of the low molecular weight polyol is too low, the number of crosslinking points is excessively small, and the heat resistance of the polyol may deteriorate. Therefore, the content of the low molecular weight polyol is preferably 1.0 mass % or more.

Meanwhile, when the content of the low molecular weight polyol is excessive, the polyurethane foam may be excessively hard. Therefore, the content of the low molecular weight polyol is preferably 5.0 mass % or less. The content is more preferably 4.0 mass % or less, and still more preferably 3.0 mass % or less.

### [D. Content of Polymer Polyol]

The “content (mass %) of the polymer polyol” refers to the ratio of the mass of the polymer polyol to the total mass of the polyol.

The raw material mixture may not contain a polymer polyol. However, when the raw material mixture contains a polymer polyol, the rigidity of the polyurethane foam may be improved. In order to obtain such an effect, the content of the polymer polyol is preferably 5.0 mass % or more.

Meanwhile, when the content of the polymer polyol becomes excessive, the content of the castor oil-based polyol becomes relatively low, and the heat resistance of the polyurethane foam may decrease. Therefore, the content of the polymer polyol is preferably 15.0 mass % or less. The content is more preferably 13.0 mass % or less, or 12.0 mass % or less.

### [E. Total EO Content]

The “total EO content (mass %)” refers to the ratio of the total mass of ethylene oxide units contained in the polyol to the total mass of alkylene oxide units contained in the polyol.

When the total EO content of the polyol contained in the raw material of the polyurethane foam becomes too high, compatibility of the raw material decreases, bubbles excessively communicate with each other, and as a result, air permeability of the polyurethane foam may increase. Therefore, the total EO content needs to be 10.0 mass % or less. The total EO content is preferably 5.0 mass % or less, 3.0 mass % or less, or 1.0 mass % or less.

### [1.2. Polyisocyanate]

### [1.2.1. Materials]

Polyisocyanate is another main raw material for producing a polyurethane foam. In the invention, the type of the polyisocyanate is not particularly limited. The raw material may contain one type of polyisocyanate or two or more types thereof.

Examples of the polyisocyanate include:
(a) an aromatic isocyanate compound, an aliphatic isocyanate compound, or an alicyclic isocyanate compound; and
(b) a modified product of the compound.

Examples of the aromatic isocyanate compound include
diphenylmethane diisocyanate (MDI),
crude diphenylmethane diisocyanate, tolylene diisocyanate (TDI),
naphthalene diisocyanate (NDI),
p-phenylene diisocyanate (PPDI), xylene diisocyanate (XDI),
tetramethyl xylene diisocyanate (TMXDI), and
tolidine diisocyanate (TODI).

Examples of the aliphatic isocyanate compound include
hexamethylene diisocyanate (HDI), lysine diisocyanate (LDI), and
lysine triisocyanate (LTI).

Examples of the alicyclic isocyanate compound include
isophorone diisocyanate (IPDI),
cyclohexyl diisocyanate (CHDI), hydrogenated XDI (H₆XDI), and hydrogenated MDI (H₁₂MDI).

Examples of the modified isocyanate compound include a urethane-modified product, a dimer, a trimer, a carbodiimide-modified product, an allophanate-modified product, a biuret-modified product, a urea-modified product, an isocyanurate-modified product, an oxazolidone-modified product, and an isocyanate group-terminated prepolymer of the isocyanate compound.

Among them, the polyisocyanate is preferably an MDI-based isocyanate.

Here, the “MDI-based isocyanate” refers to
(a) MDI, a polynuclear form of MDI, or a modified product of MDI, or
(b) a mixture of two or more types selected from the group consisting of MDI, a polynuclear form of MDI, and a modified product of MDI.

When the reactivity of the polyisocyanate is too low, bubbles may escape from the raw material mixture before the raw material mixture is cured, and it may be difficult to form a foam. Meanwhile, when the reactivity of the polyisocyanate is too high, the reaction becomes extremely fast, and it may be difficult to mold the polyisocyanate by a mechanical froth method.

Meanwhile, since the MDI-based isocyanate has moderate reactivity, a foam in which bubbles are uniformly dispersed can be easily obtained.

### [1.2.2. Isocyanate Index]

The “isocyanate index” refers to a value obtained by multiplying the ratio of the equivalent of isocyanate groups of the polyisocyanate in the raw material mixture to the equivalent of active hydrogen groups in the raw material mixture by 100.

When the isocyanate index becomes too small, the number of crosslinking points decreases, and as a result, the heat resistance of the polyurethane foam may decrease. Therefore, the isocyanate index is preferably 80 or more. The isocyanate index is more preferably 85 or more or 90 or more.

Meanwhile, when the isocyanate index is too large, the number of crosslinking points become excessive, and the polyurethane foam may be excessively hard. Therefore, the isocyanate index is preferably 120 or less. The isocyanate index is more preferably 115 or less or 110 or less.

### [1.3. Foam Stabilizer]

### [1.3.1. Materials]

The foam stabilizer is for facilitating dispersion of entrainment gas, stabilizing air bubbles, and adjusting the bubble structure when the raw material mixture is mechanically foamed. In the invention, the type of the foam stabilizer is not particularly limited.

Examples of the foam stabilizer include
(a) a silicone-based foam stabilizer,
(b) a fluorine-containing compound-based foam stabilizer,
(c) an anionic surfactant such as sodium dodecylbenzene sulfonate or sodium lauryl sulfate, and
(d) a phenol-based compound.

The raw material mixture may contain any one type of these foam stabilizers, or may contain two or more types thereof.

Among them, the foam stabilizer is preferably a silicone-based foam stabilizer. The silicone-based foam stabilizer is easier than other foam stabilizers to control the degree of bubble communication.

Specific examples of the silicone-based foam stabilizer include
(a) a sodium salt of sulfonated ricinoleic acid,
(b) a mixture of a sodium salt of sulfonated ricinoleic acid and a polysiloxane/polyoxyalkylene copolymer,
(c) dimethylpolysiloxane oil, and
(d) oil obtained by substituting some of methyl groups of dimethylpolysiloxane oil with organic functional groups.

### [1.3.2. Content]

The “content of the foam stabilizer” refers to the total mass of the foam stabilizer when the mass of the polyol is 100.

When the content of the foam stabilizer becomes too small, it may be difficult to form a foam. Therefore, the content of the foam stabilizer is preferably 3.0 parts by mass or more. The content is more preferably 4.0 parts by mass or more, or 5.0 parts by mass or more.

Meanwhile, even when the foam stabilizer is added more than necessary, there is no difference in effect, and there is no practical advantage. Therefore, the content of the foam stabilizer is preferably 30.0 parts by mass or less. The content is more preferably 15.0 parts by mass or less, or 10.0 parts by mass or less.

### [1.4. Catalyst]

### [1.4.1. Materials]

The catalyst is for promoting a resinification reaction. In the invention, the type of the catalyst is not particularly limited. Examples of the catalyst include:
(a) Fe-based catalysts such as iron acetylacetonate;
(b) Ni-based catalysts such as nickel acetylacetonate, nickel octylate, or nickel naphthenate;
(c) Sn-based catalysts such as stannous octoate or dibutyltin dilaurate; and
(d) Pb-based catalysts such as lead octenate.

The raw material mixture may contain any one type of these catalysts, or may contain two or more types thereof.

### [1.4.2. Content]

The “content of the catalyst” refers to the total mass of the catalyst when the mass of the polyol is 100.

In general, as the content of the catalyst increases, the resinification reaction proceeds in a shorter time. In order to obtain such an effect, the content of the catalyst is preferably 0.001 parts by mass or more. The content is more preferably 0.005 parts by mass or more, or 0.01 parts by mass or more.

Meanwhile, when the content of the catalyst becomes excessive, the polyurethane foam may be excessively hard. Therefore, the content of the catalyst is preferably 1.0 parts by mass or less. The content is more preferably 0.04 parts by mass or less, or 0.02 parts by mass or less.

### [1.5. Foaming Gas]

### [1.5.1. Materials]

The foaming gas is not particularly limited as long as the foaming gas does not adversely affect the reaction between the polyol and the polyisocyanate.

Examples of the foaming gas include
(a) dry air and
(b) inert gas such as nitrogen.

### [1.5.2. Content]

The “content of the foaming gas” refers to the volume of the foaming gas when the volume of the raw material excluding the foaming gas is 100.

When the content of the foaming gas becomes too small, foaming may be insufficient. Therefore, the content of the foaming gas is preferably 10 parts by volume or more. The content is more preferably 40 parts by volume or more, or 50 parts by volume or more.

Meanwhile, when the content of the foaming gas becomes excessive, bubbles are more likely to break or coalesce in the foamed liquid. Therefore, the content of the foaming gas is preferably 95 parts by volume or less. The content is more preferably 85 parts by volume or less, or 75 parts by volume or less.

### [1.6. Other Components]

The raw material mixture for producing the polyurethane foam may further contain the following components in addition to the above-described components. The addition amount of each component is not particularly limited, and it is preferable to select an optimum addition amount according to the purpose.

### [1.6.1. Water Absorbent]

The raw material mixture may contain a water absorbent. The water absorbent is for removing moisture contained in the raw material mixture and suppressing the polyisocyanate from reacting with moisture. When the polyisocyanate reacts with moisture, CO₂ gas is generated, and it may be difficult to control bubbles. In the invention, the type of the water absorbent is not particularly limited.

Examples of the water absorbent include molecular sieve, synthetic zeolite, silica powder, alumina powder, lithium hydroxide powder, and barium hydroxide powder.

### [1.6.2. Antioxidant]

The raw material mixture may contain an antioxidant. The antioxidant is for suppressing deterioration of polyurethane due to oxidation. In the invention, the type of the antioxidant is not particularly limited.

Examples of the antioxidant include hindered phenol antioxidants, amine antioxidants, sulfur antioxidants, and phosphorus antioxidants.

### [1.6.3. Filler]

The raw material mixture may contain a filler. The filler is for increasing the volume of the polyurethane foam, reducing the amount of the polyurethane raw material used per unit volume, and reducing the cost of the polyurethane foam. In the invention, the type of the filler is not particularly limited.

Examples of the filler include aluminum hydroxide, calcium carbonate, talc, and clay.

### [1.6.4. Foam Retention Agent]

The raw material mixture may contain a foam retention agent. The foam retention agent is for increasing the viscosity of the raw material mixture and suppressing bubbles from escaping from the raw material mixture before the raw material mixture is cured. In the invention, the type of the foam retention agent is not particularly limited as long as the foam retention agent can be uniformly dispersed in the polyol. Examples of the foam retention agent include hydrophobic silica.

### [1.6.5. Colorant]

The raw material mixture may contain a colorant. The colorant is for coloring the polyurethane foam into a desired color. In the invention, the type of the colorant is not particularly limited.

Examples of the colorant include carbon black, titanium oxide, a mineral pigment, an organic pigment, and a dye.

### [1.7. Reaction of Raw Material Mixture]

The polyurethane foam according to the invention is produced using a mechanical froth method. The “mechanical froth method” refers to a method in which
(a) a raw material mixture is mixed while an inert gas is blown using a highly shearing mixer to obtain a foamed raw material mixture containing fine bubbles,
(b) the foamed raw material mixture is applied to the surface of a substrate (for example, a PET film), and
(c) a coating film is heated to a predetermined temperature and cured.

In the invention, the reaction conditions of the raw material mixture are not particularly limited, and optimal conditions can be selected according to the purpose.

### [1.8. Characteristics]

### [1.8.1. Gurley Air Permeability]

The “Gurley air permeability” refers to a value measured in accordance with JIS P 8117:2009.

The polyurethane foam according to the invention exhibits low air permeability because the type and content of each raw material are optimized. When the production conditions are optimized, the Gurley air permeability is 3.0 seconds or more. When the production conditions are further optimized, the Gurley air permeability is 4.0 seconds or more, 10.0 seconds or more, 50.0 seconds or more, or 100.0 seconds or more.

### [1.8.2. Compression Set]

The “compression set” refers to a value measured in accordance with JIS K 6401:2011.

The polyurethane foam according to the invention exhibits high heat resistance because the type and content of each raw material are optimized. When the production conditions are optimized, the compression set at 100° C. is 10.0% or less. When the production conditions are further optimized, the compression set at 100° C. is 9.0% or less, 8.0% or less, or 7.0% or less.

### [1.8.3. Density]

The “density” refers to a value measured in accordance with JIS K 6401:2011.

In the polyurethane foam according to the invention, the density can be controlled in a relatively wide range by controlling the expansion ratio. By optimizing the production conditions, a polyurethane foam having a density of 50 kg/m³ or more and 900 kg/m³ or less is obtained. The density is preferably 100 kg/m³ or more and 600 kg/m³ or less, or 150 kg/m³ or more and 500 kg/m³ or less.

### [1.9. Application]

The polyurethane foam according to the invention can be used for:
(a) a cushioning material around a battery or an electronic control unit of an electric vehicle;
(b) a cushioning material around a stationary storage battery;
(c) a sealing material of a sealing portion of a solar cell; and the like.

The polyurethane foam according to the invention is suitable as a cushioning material around a battery.

### [2. Action]

In the case of reacting a raw material mixture containing a polyol, a polyisocyanate, a foam stabilizer, a catalyst, and a foaming gas, when a castor oil-based polyol is used as the polyol, a polyurethane foam having higher heat resistance than when only a polyether polyol is used is obtained. This is considered to be because the castor oil-based polyol contains an ester bond, and the thermal stability of the ester bond is higher than that of the ether bond.

When a polyol having a low total EO content is used as the polyol, a polyurethane foam having low air permeability is obtained. This is considered to be because lowering the total EO content of the polyol improves the compatibility of the raw materials and suppresses excessive communication of air bubbles.

### EXAMPLES

### Examples 1 to 4 and Comparative Examples 1 to 3

### [1. Preparation of Sample]

[1.1. Raw materials]

As the polyether polyol, the following was used.

### (1) Polyether Polyol A:

Product name “Sannix (registered trademark) FA-103”, manufactured by Sanyo Chemical Industries, Ltd.

### (2) Polyether Polyol B:

Product name: “Sannix (registered trademark) GP-600”, manufactured by Sanyo Chemical Industries, Ltd.

### (3) Polyether Polyol C:

Product name “Prime Pole (registered trademark) FF-3320”, manufactured by Sanyo Chemical Industries, Ltd.

### (4) Polyether Polyol D:

Product name “Sannix (registered trademark) PP-2000”, manufactured by Sanyo Chemical Industries, Ltd.

### (5) Polyether Polyol E:

Product name “Sannix (registered trademark) PP-400”, manufactured by Sanyo Chemical Industries, Ltd.

As the polyester polyol, the following was used.

### (1) Polyester Polyol a (Castor Oil-Based Polyol):

Product name “Deodorized refined castor oil”, manufactured by HOKOKU CORPORATION

### (2) Polyester Polyol B (Castor Oil-Based Polyol):

Product name “URIC AC-009”, manufactured by Itoh Oil Chemicals Co., Ltd.

### (3) Polyester Polyol C (Polycaprolactone Diol):

Product name “PLACCEL 205 U”, manufactured by Daicel Corporation

### (4) Polyester Polyol D (Adipate):

Product name “ADEKA NEWACE (registered trademark) Y65-55”, manufactured by ADEKA CORPORATION,

As the polymer polyol, the following was used.

### (1) Polymer Polyol A:

Product name “EXCENOL (registered trademark) 913”, manufactured by AGC Inc.

### (2) Polymer Polyol B:

Product name “EXCENOL (registered trademark) 914”, manufactured by AGC Inc.

As the low molecular weight polyol, the following was used.
(1) Low molecular weight polyol A: dipropylene glycol, manufactured by AGC Inc.
(2) Low molecular weight polyol B: 2-methyl-1,3-propanediol, manufactured by AGC Inc.

As the water absorbent and the antioxidant, the following materials were used.
(1) Water absorbent: product name “Molsiv Adsorbents 3A Powder”, manufactured by UOP LLC
(2) Antioxidant (hindered phenol): product name “SONGNOX 1135 LQ/IRGANOX”, manufactured by Songwon Industrial Co., Ltd/BASF Japan Ltd.

As the filler, the following was used.
(1) Filler A (aluminum hydroxide): product name “HYDILITE (registered trademark) H-21/aluminum hydroxide”, manufactured by Showa Denko K.K./Almolix Co., Ltd.
(2) Filler B (aluminum hydroxide): product name “aluminum hydroxide C-31”, manufactured by Sumitomo Chemical Co., Ltd.
(3) Filler C (calcium carbonate): product name “Silver W”, manufactured by Shiraishi Calcium Kaisha, Ltd.

As the foam retention agent and the foam stabilizer, the following agents were used.
(1) Foam retention agent (hydrophobic silica): product name “SS-80K”, manufactured by Tosoh Silica Corporation
(2) Foam stabilizer A: product name “VORASURF (registered trademark) SZ-1952 Additive”, manufactured by Dow Toray Co., Ltd.
(3) Foam stabilizer B: product name “SZ-1968”, manufactured by Dow Toray Co., Ltd.
(4) Foam stabilizer C: product name “SZ-1718”, manufactured by Dow Toray Co., Ltd.

As the catalyst, the following was used.
(1) Catalyst A (Fe-based catalyst): product name “FIN-PA1/LT CAT”, manufactured by Nippon Chemical Industrial Co., Ltd./PAN Chemical Co., Ltd., catalyst component content: 0.25 mass %
(2) Catalyst B (Ni-based catalyst): product name “NIAX CATALYST LC-5615”, manufactured by Momentive Performance Materials Japan LLC, catalyst component content: 15.0 mass %

As the polyisocyanate, the following was used.
(1) Polyisocyanate A (crude MDI): NCO group content 31.5%, product name “LUPRANATE (registered trademark) M5S Ex Korea”, manufactured by BASF Japan Ltd.
(2) Polyisocyanate B (pure MDI): NCO group content 33.57%, product name “FOAMLITE (registered trademark) MI”, manufactured by BASF INOAC POLYURETHANE CO., LTD.
(3) Polyisocyanate C (carbodiimide-modified MDI): NCO group content 30.88%, product name “Millionate MTL-S”, manufactured by Tosoh Corporation

The above raw materials were blended at a predetermined ratio. The raw material mixture was charged into a mixing head, and stirred and mixed to be homogeneous while an inert gas (nitrogen) was mixed, thereby obtaining a foaming raw material mixture containing fine bubbles. The foaming raw material mixture was applied onto a PET film, and the coating film was heated and cured at 200° C.

### [2. Test Method]

### [2.1. Thickness]

The thickness of the polyurethane foam was measured using a thickness measuring instrument manufactured by Peacock.

### [2.2. Density]

The density of the polyurethane foam was measured in accordance with JIS K 6401:2011.

### [2.3. Gurley Air Permeability]

The Gurley air permeability of a polyurethane foam was measured in accordance with JIS P 8117:2009. As a tester, a sealed type (B type) was used.

### [2.4. Compression Set]

The compression set of the polyurethane foam was measured in accordance with JIS K 6401:2011.

That is, the polyurethane foam was held at a predetermined temperature for 22 hours in a compressed state. The compression ratio was set to 50%, and the holding temperature was set to 70° C. or 100° C. The compression set was calculated from the change in thickness before and after holding.

### [3. Results]

Table 1 shows the results. Table 1 also shows the raw material composition of each sample. The numerical value of the raw material composition represents parts by mass. In Table 1, “OHV” represents the hydroxyl value (mgKOH/g), “f” represents the functionality, “MW” represents the molecular weight, and “EO ratio” represents the EO content (mass %). Table 1 shows the following.
(1) In Comparative Example 1, the compression set at 100° C. exceeded 10.0%. This is considered to be because no castor oil-based polyol is used.
(2) In Comparative Example 2, the compression set at 100° C. exceeded 10.0%. This is considered to be because no castor oil-based polyol is used.
(3) In Comparative Example 3, the Gurley air permeability was 0.5 seconds. This is considered to be because the total EO content exceeds 10.0 mass %.
(4) In all of Examples 1 to 4, the Gurley air permeability was 3.0 seconds or more, and the compression set at 100° C. was 10.0% or less.
(5) In particular, in Examples 2 to 4, the Gurley air permeability was 100 seconds or more. This is considered to be because the total EO content is less than 4.0 mass %.

TABLE 1

| | | | | | | | | | Compar- | Compar- | Compar- |
|---|---|---|---|---|---|---|---|---|---|---|---|
| | | | | | Exam- | Exam- | Exam- | Exam- | ative | ative | ative |
| Classification | Name of substance | OHV | f | MW | ple 1 | ple 2 | ple 3 | ple 4 | Example 1 | Example 2 | Example 3 |
| Polyether polyol A | Polyoxyalkylene (C2, C3) | 50 | 3 | 3346 | 5.5 | | | | | | 39.6 |
| | polyol | | | | | | | | | | |
| Polyether polyol B | | 281 | 3 | 600 | 47.6 | 50.6 | 50.4 | | | | 9.7 |
| Polyether polyol C | | 56 | 3 | 3000 | | | | 45.8 | | | |
| Polyether polyol D | Polyoxypropylene glycol | 56 | 2 | 2000 | 8.9 | 9.4 | 9.4 | | 42.6 | | |
| Polyether polyol E | Polyoxypropylene glycol | 281 | 2 | 400 | | | | | 3.7 | | |
| Polyester polyol A | Castor oil-based polyol | 163 | 2.7 | 929 | 35.2 | 37.1 | 37.3 | | | | |
| Polyester polyol B | Castor oil-based polyol | 225 | 2.5 | 625 | | | | 45.2 | | | 50.7 |
| Polyester Polyol C | Polycaprolactone diol | 212 | 2.0 | 529 | | | | | 14.1 | | |
| Polyester polyol D | Adipate | 212 | 2.0 | 529 | | | | | | 14.2 | |
| Polymer polyol A | | 29 | 2.0 | 3000 | | | | | 20.9 | 45.7 | |
| Polymer polyol B | | 43 | 3.0 | 3000 | | | | 9.0 | 9.5 | 34.7 | |
| Low molecular | Dipropylene glycol | 837 | 2.0 | 134 | 2.8 | 2.9 | 2.9 | | 7.9 | 5.4 | |
| weight polyol A | | | | | | | | | | | |
| Low molecular | 2-methyl-1, 3-propanediol | 1245 | 2.0 | 90 | | | | | 1.3 | | |
| weight polyol B | | | | | | | | | | | |
| Total polyols | | | | | 100.0 | 100.0 | 100.0 | 100.0 | 100.0 | 100.0 | 100.0 |
| Water absorbent | | | | | 2.2 | 2.3 | 2.4 | 2.5 | 2.6 | | 2.7 |
| Antioxidant | Hindered phenol | | | | 0.1 | 0.1 | 0.1 | 0.1 | 0.1 | | 0.1 |
| Filler A | Aluminum hydroxide | | | | 33.5 | 35.2 | | 26.6 | | | 34.3 |
| | (average particle | | | | | | | | | | |
| | size: 25 μm) | | | | | | | | | | |
| Filler B | Aluminum hydroxide | | | | | | | | 26.3 | 22.5 | |
| | (average particle | | | | | | | | | | |
| | size: 50 μm) | | | | | | | | | | |
| Filler C | Calcium carbonate | | | | | | 35.4 | | | | |
| Foam retention agent | Silica | | | | 2.2 | 2.3 | 2.4 | | | | |
| Foam stabilizer A | | 40 | 1.0 | 1400 | 8.9 | 9.4 | 9.4 | 1.6 | 5.6 | 3.9 | 4.1 |
| Foam stabilizer B | | 40 | 1.0 | | | | | 4.0 | | | |
| Catalyst A | Iron(III) acetylacetonate | | | | 0.017 | 0.018 | 0.018 | 0.017 | 0.020 | | 0.014 |
| Catalyst B | Bis(acetylacetonato- | | | | | | | | | 0.07 | |
| | O,O′)nickel | | | | | | | | | | |
| Polyisocyanate A | Crude MDI | 32 | 2.4 | 320 | | | | 34.1 | 39.6 | | 40.7 |
| Polyisocyanate B | Pure MDI | 34 | 2.0 | 252 | 53.3 | 56.1 | 57.4 | | | | |
| Polyisocyanate C | Carbodiimide- | 31 | | | | | | | | 25.5 | |
| | modified MDI | | | | | | | | | | |
| INDEX | | | | | 106 | 107 | 109 | 107 | 105 | 101 | 105 |
| Total EO | | | | | 4 | 0 | 0 | 0 | 5 | 10 | 32 |
| content [wt %] | | | | | | | | | | | |

| | | | | | | | |
|---|---|---|---|---|---|---|---|
| Physical properties | | | | | | | |
| Thickness [mm] | 2.7 | 2.7 | 0.5 | 2.7 | 4.8 | 3.0 | 3.0 |
| Density [kg/m³] | 200 | 170 | 240 | 200 | 240 | 200 | 240 |
| Gurley air permeability [s] | 10.0 | Unmeas- | 130.0 | Unmeas- | 4.0 | 3.0 | 0.5 |
| | | urable | | urable | | | |
| Compression set (70° C.) [%] | 1 | 1 | 1 | 1 | 1 | 4 | 1 |
| Compression set (100° C.) [%] | 5 | 5 | 5 | 6 | 25 | 43 | 5 |

Although the embodiments of the invention have been described in detail above, the invention is not limited to the above embodiments at all, and various modifications can be made without departing from the gist of the invention.

### INDUSTRIAL APPLICABILITY

The polyurethane foam according to the invention can be used for a cushioning material around a battery or an electronic control unit of an electric vehicle, a cushioning material around a stationary storage battery, a sealing material of a sealing portion of a solar cell, and the like.

1. (canceled)

2. (canceled)

3. (canceled)

4. (canceled)

5. A polyurethane foam obtained by reacting a raw material mixture containing a polyol, wherein:
the polyurethane foam is formed of a product obtained by reacting the raw material mixture using a mechanical froth method;
the polyol:
contains a castor oil-based polyol and a low molecular weight polyol,
has a total EO content of 10.0 mass % or less, and
has a content of the low molecular weight polyol of 1.0 mass % or more and 4.0 mass % or less;
the “low molecular weight polyol” refers to a compound having:
(a) a hydroxyl value exceeding 800 mgKOH/g, and
(b) a functionality of 2 or more; and
the “content of the low molecular weight polyol” refers to a ratio of a mass of the low molecular weight polyol to a total mass of the polyol.

6. The polyurethane foam according to claim 5, wherein the raw material mixture does not contain water.

7. The polyurethane foam according to claim 5, wherein the raw material mixture includes iron(III) acetylacetonate as a catalyst.

8. The polyurethane foam according to claim 5, wherein the polyol has a total EO content of 1.0 mass % or more and 5.0 mass % or less.

9. The polyurethane foam according to claim 5, wherein a Gurley air permeability is 3.0 seconds or more.

10. The polyurethane foam according to claim 5, wherein a compression set at 100° C. is 10.0% or less.

11. A cushioning material around a battery, comprising the polyurethane foam according to claim 5.

12. The cushioning material around a battery according to claim 11, wherein at least one condition selected from the group consisting of the following (a) to (e) is further satisfied:
(a) the raw material mixture contains iron(III) acetylacetonate as a catalyst,
(b) the raw material mixture contains a water absorbent material,
(c) the raw material mixture contains silica,
(d) the raw material mixture contains an antioxidant, and
(e) the polyol contains a polyether polyol having a hydroxyl value of 281 mgKOH/g or more and 800 mgKOH/g or less.
